(19) United States
(12) Patent Application Publication
(10) Pub. No.: US 2006/0250565 A1
(43) Pub. Date: Nov. 9, 2006

(54) Image display device and method of manufacturing the same

(76) Inventors: Takashi Enomoto, Fukaya-shi (JP); Akiyoshi Yamada, Fukaya-shi (JP); Tsukasa Ooshima, Takasaki-shi (JP); Masahiro Yokota, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/480,852

(22) Filed: Jul. 6, 2006

Related U.S. Application Data
(63) Continuation of application No. PCT/JP04/18754, filed on Dec. 15, 2004.

(30) Foreign Application Priority Data
Jan. 6, 2004 (JP) 2004-001052

(51) Int. Cl. G02F 1/1339

(52) U.S. Cl. 349/153

(57) ABSTRACT

A first substrate and a second substrate located opposite each other with a gap therebetween are sealed at a predetermined position by a sealing portion and which seals the front and rear substrates in a given position and defines a sealed space between the front and rear substrates. The sealing portion has a ground layer formed on an inner surface of at least one of the first substrate and the second substrate, and a sealing layer made of an electrically conductive sealant and formed on the ground layer, the ground layer having a thickness of 5 to 22 μm.

### CROSS-REFERENCE TO RELATED APPLICATIONS

This is a Continuation Application of PCT Application No. PCT/JP2004/018754, filed Dec. 15, 2004, which was published under PCT Article 21(2) in Japanese.

This application is based upon and claims the benefit of priority from prior Japanese Patent Application No. 2004-001052, filed Jan. 6, 2004, the entire contents of which are incorporated herein by reference.

### BACKGROUND OF THE INVENTION

1. Field of the Invention

This invention relates to an image display device, having two substrates located opposite each other and a sealing portion that seals these substrates together, and a method manufacturing the same.

2. Description of the Related Art

In recent years, various flat image display devices have been-noticed as a next generation of lightweight, thin display devices to replace cathode-ray tubes (hereinafter, referred to as CRTs). These image display devices include a liquid crystal display (hereinafter, referred to as an LCD), plasma display panel (hereinafter, referred to as a PDP), field emission device (hereinafter, referred to as an FED), surface-conduction electron emission device (hereinafter, referred to as a SED), etc. The LCD utilizes the orientation of a liquid crystal to control the intensity of light. The PDP uses ultraviolet rays produced by plasma discharge to excite phosphors to luminescence. The FED uses electron beams from field-emission electron emitting elements to excite phosphors to luminescence. The SED uses electron beams from surface-conduction electron emitting elements to excite phosphors to luminescence.

The FED or SED, for example, generally comprises a front substrate and a rear substrate that are opposed to each other across a predetermined gap. These substrates have their respective peripheral portions joined together by a sidewall in the form of a rectangular frame, thereby forming a vacuum envelope. A phosphor screen is formed on the inner surface of the front substrate. Provided on the inner surface of the rear substrate are a large number of electron emitting elements for use as electron emission sources, which excite the phosphors to luminescence.

In order to support the atmospheric load that acts on the rear substrate and the front substrate, a plurality of support members are arranged between these substrates. A potential on the rear substrate side is substantially equal to the ground potential, and an anode voltage is applied to the phosphor screen. Electron beams emitted from the electron emitting elements are applied to red, green, and blue phosphors that constitute the phosphor screen, and an image is displayed by causing the phosphors to glow.

According to the FED or SED constructed in this manner, the thickness of the display device can be reduced to about several millimeters, so that the device can be made lighter in weight and thinner than CRTs that are used as displays of existing TVs or computers.

For the FED, for example, various manufacturing methods have been examined to join the front substrate and the rear substrate that constitute the envelope by means of the sidewall in the form of a rectangular frame. A method may be given as an example in which the front substrate and the rear substrate are baked at about 350° C. in, for example, a vacuum device in a manner such that the substrates are kept distant enough from each other as the entire vacuum device is evacuated to high vacuum. When a given temperature and a given degree of vacuum are attained, according to this method, the front substrate and the rear substrate are joined together with the sidewall. Normally, in this method, indium that can serve for sealing at a relatively low temperature is used as a sealant the adsorption capacity of a getter being lowered. Disclosed in Jpn. Pat. Appln. KOKAI Publication No. 2002-184331, for example, is a method in which sealing is performed in the following manner. A material such as a silver paste that has good airtightness and wettability with the indium is formed in advance as a ground layer on a substrate by printing lest an undesired flow be generated when the indium melts. The indium is loaded onto the ground layer to form a frame-shaped sealing layer, and this sealing layer is melted.

Although indium is a low-melting-point metal, however, its melting temperature is about 160° C., at which the adsorption capacity of the getter is found to be reduced. It was empirically confirmed that the life performance lowered when the sealed display device was operated at this temperature.

A method described in, for example, Jpn. Pat. Appln. KOKAI Publication No. 2002-319346 is studied as a method to solve these problems. In this method (hereinafter referred to as electric heating), current is supplied to indium or some other low-melting-point metal for use as a sealant, and the sealant itself is heated and melted by the resulting Joule heat to seal substrates together. According to this method, only the sealant can be heated to high temperature without failing to keep a getter forming region at low temperature, so that the adsorption capacity of a getter can be prevented from being reduced. Since the time required for the sealing can be shortened to 10 minutes or less, moreover, manufacturing costs can be reduced considerably.

According to the electric heating described above, however, the cross-sectional area of the molten sealant changes with time and the sealant flows in an undulating manner as a whole, under the influence of changes of the surface tension and viscosity of the sealant, which are attributable to a sudden temperature change, and a magnetic field generated in the sealant by current supply. The sealant that is heated up to 350° C., in particular, has its surface irregularities greater than before heating, and its cross-sectional area changes more drastically when it is energized. Accordingly, there arises a problem that the sealant arranged in the form of a frame inevitably undergoes breakage or fracture while it is being energized.

This breakage of the sealant occurs in most baked substrates. If the sealant is broken, the substrates naturally cannot be sealed together, and the sealant and the ground layer may possibly be ruined by the breakage. In many cases, the substrates themselves are also damaged, so that it is hard to recover and reuse the substrates. Thus, there arise new problems that the yield of a sealing process lowers and that it is difficult to efficiently manufacture satisfactory image display devices.

### SUMMARY OF THE INVENTION

This invention has been made in consideration of these circumstances, and its object is to provide an image display device, in which breakage of a sealant can be prevented during electric heating and sealing can be performed with good efficiency and high reliability, and a method of manufacturing the same.

According to an aspect of the invention, there is provided an image display device comprising a first substrate and a second substrate located opposite each other with a gap therebetween, and a sealing portion which seals the front and rear substrates in a given position and defines a sealed space between the front and rear substrates,

the sealing portion having a ground layer formed on an inner surface of at least one of the first substrate and the second substrate, and a sealing layer made of an electrically conductive sealant and formed on the ground layer, the ground layer having a thickness of 5 to 22 μm.

According to another aspect of the invention, there is provided a method of manufacturing an image display device which comprises a first substrate and a second substrate located opposite each other with a gap therebetween and a sealing portion which seals the front and rear substrates in a given position and defines a sealed space between the front and rear substrates, the method comprising:

forming a ground layer to a thickness of 5 to 22 μm along an inner surface of at least one of the first and second substrates; forming a sealing layer of an electrically conductive sealant on the ground layer; and supplying current to the sealing layer to heat and melt the sealing layer with the front and rear substrates opposed to each other with the ground layer and the sealing layer sandwiched therebetween, and bonding the front and rear substrates together with the molten sealant.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an entire body of an FED according to an embodiment of this invention;

FIG. 2 is a perspective view showing an internal configuration of the FED;

FIG. 3 is a sectional view taken along line III-III of FIG. 1;

FIG. 4 is a plan view enlargedly showing a part of a phosphor screen of the FED;

FIG. 5 is a sectional view enlargedly showing a sealing portion of the FED;

FIG. 6 is a sectional view showing a configuration of the sealing portion in detail;

FIG. 7A is a plan view showing a state in which a ground layer is formed on a front substrate used in the manufacture of the FED;

FIG. 7B is a plan view showing a state in which a ground layer is formed on a rear substrate used in the manufacture of the FED;

FIG. 8A is a plan view showing a state in which a sealing layer is formed on the front substrate;

FIG. 8B is a plan view showing a state in which a sealing layer is formed on the rear substrate;

FIG. 9 is a perspective view showing a state in which electrodes are attached to the rear substrate of the FED;

FIG. 10 is a diagram schematically showing a vacuum processor used in the manufacture of the FED;

FIG. 11 is a sectional view showing a state in which the rear substrate and the front substrate having indium thereon are opposed to each other; and

FIG. 12 is a plan view typically showing a state in which a power source is connected to the electrodes of the FED in a manufacturing process for the FED.

### DETAILED DESCRIPTION OF THE INVENTION

An embodiment in which an image display device according to this invention is applied to an FED will now be described in detail with reference to the drawings.

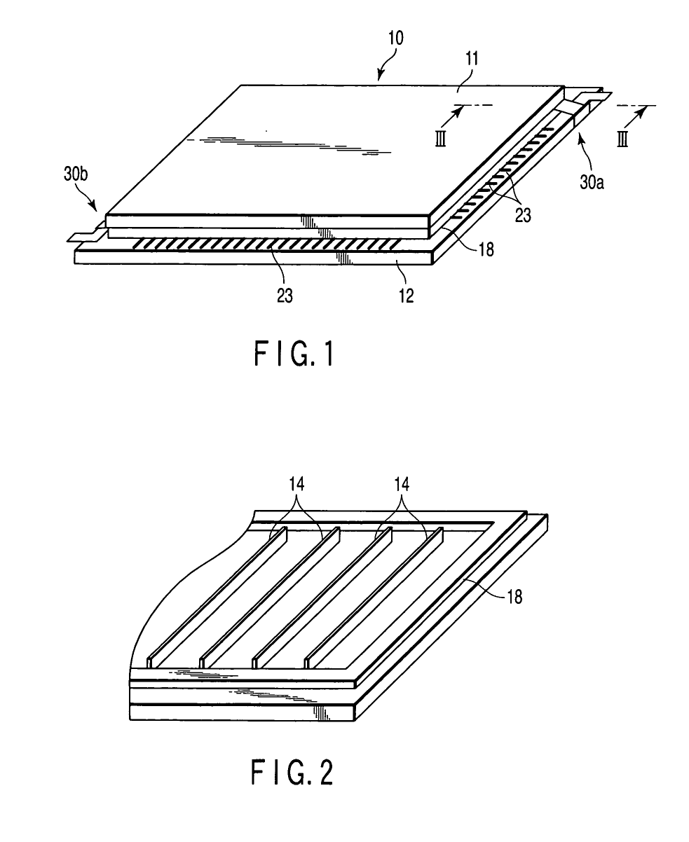

As shown in FIGS. 1 to 4, the FED comprises a front substrate 11 and a rear substrate 12, which are formed of a rectangular glass substrate each and function as first and second substrates, respectively. These substrates are located opposite each other with a given space between them. The rear substrate 12 is formed having a size larger than that of the front substrate 11. The front substrate 11 and the rear substrate 12 have their respective peripheral edge portions joined together by a sidewall 18 in the form of a rectangular frame, thereby forming a flat rectangular vacuum envelope 10 of which the internal space is kept at high vacuum.

A plurality of plate-like support members 14 are provided in the vacuum envelope 10 in order to support an atmospheric load that acts on the front substrate 11 and the rear substrate 12. These support members 14 individually extend in a direction parallel to one side of the vacuum envelope 10 and are arranged at given intervals along a direction perpendicular to the one side. The support members are not limited to the plate-like shape but may be columnar.

A phosphor screen 16 that functions as an image display screen is formed on the inner surface of the front substrate 11. The phosphor screen 16 is formed by arranging phosphor layers R, G and B, which glow red, green, and blue, respectively, and light shielding layers 20 situated between the phosphor layers. The phosphor layers R, G and B extend in a direction parallel to the one side of the vacuum envelope 10 and are arranged at given intervals in a direction perpendicular to the one side. A metal back layer 17 of aluminum and a getter film 27 of barium, for example, are successively formed in layers on the phosphor screen 16.

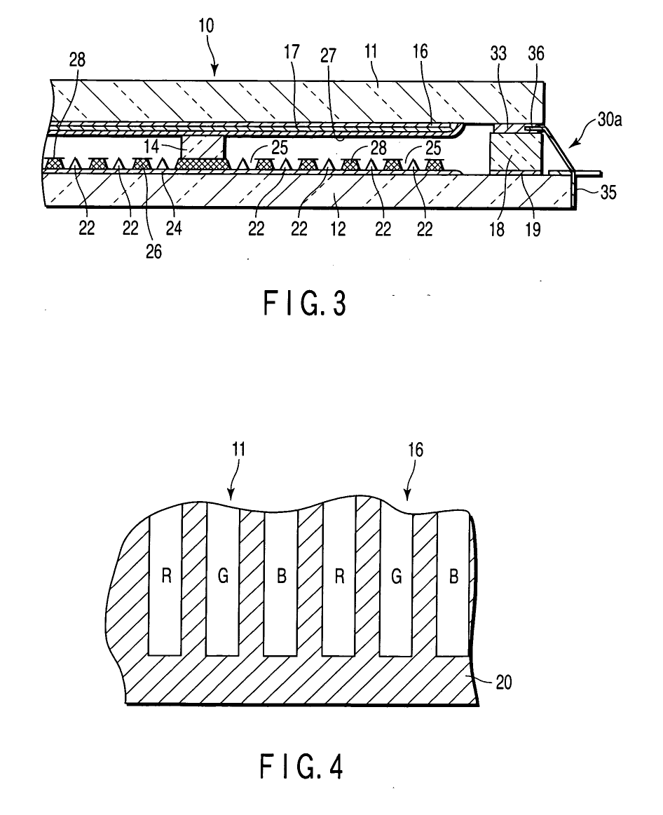

Provided on the inner surface of the rear substrate 12, as shown in FIG. 3, are a large number of electron emitting elements 22, which individually emit electron beams as electron emission sources for exciting the phosphor layers of the phosphor screen 16. These electron emitting elements 22 are arranged in a plurality of columns and a plurality of rows corresponding to one another for each pixel. Specifically, a conductive cathode layer 24 is formed on the inner surface of the rear substrate 12, and a silicon dioxide film 26 is having a large number of cavities 25 is formed on the conductive cathode layer. Gate electrodes 28 of molybdenum or niobium are formed on the silicon dioxide film 26. The electron emitting elements 22 of molybdenum or the like, cone-shaped, are provided individually in the cavities 25 on the inner surface of the rear substrate 12. The conductive cathode layer and the gate electrodes are formed individually in the shape of stripes that extend at right angles to one another. A large number of wires 23 that supply potential to the conductive cathode layer and the gate electrodes are formed on the peripheral edge portion of the rear substrate 12.

As shown in FIGS. 3 and 5, the rear substrate 12 and the sidewall 18 are sealed together by a low-melting-point glass 19. Further, the front substrate 11 and the sidewall 18 are sealed together by a sealing portion 33 that includes a ground layer and a sealing layer. More specifically, as shown in FIG. 5, the sealing portion 33 has a frame-shaped ground layer 31a, a frame-shaped ground layer 31b, and a sealing layer 32. The ground layer 31a is formed on a sealed surface of the sidewall 18, that is, on the upper surface of the sidewall that faces the front substrate 11. The ground layer 31b is formed on a sealed surface of the front substrate, that is, on the peripheral edge portion of the inner surface that faces the sidewall. The sealing layer 32 is provided between these ground layers. The ground layers 31a and 31b are formed of, for example, a conductive silver paste. This silver paste contains a glass component, which consists mainly of silver and lead oxide, and a solvent and a binder to form the paste. The sealing layer 32 is formed of a low-melting-point sealant, e.g., indium (In), having good conductivity for a sealant.

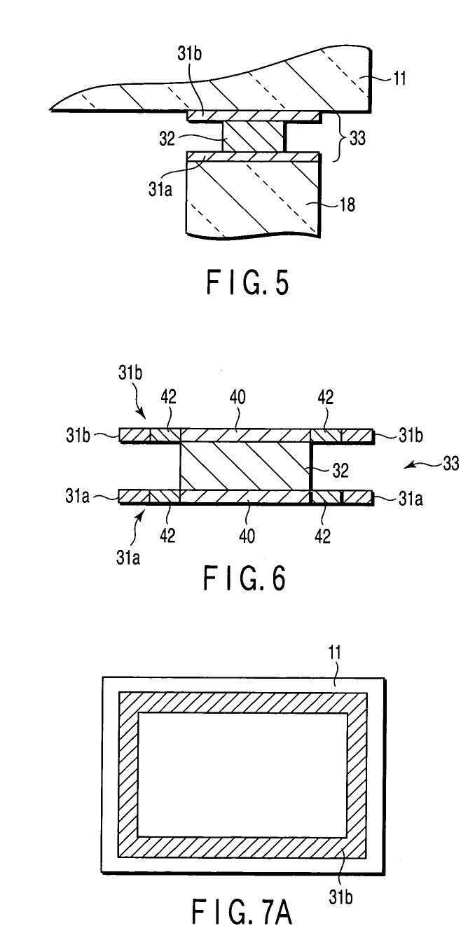

As shown in FIG. 6, that part of each of the ground layers 31a and 31b which is in contact with the sealing layer 32, a principal part of the sealing portion 33, forms a mixed layer 40 in which a ground layer material and indium are mixed. Those parts which are situated individually on the opposite sides of the mixed layer individually form bleeding portions 42 in which indium is bled and mixed with the ground layer material. Further, those parts which are situated outside the bleeding portions 42 form the ground layer 31a or 31b that are kept in its initial state without containing indium. If baking is performed during manufacturing processes, as mentioned later, the ground layer material is fully mixed with indium, so that a boundary between the sealing layer 32 and each mixed layer 40 sometimes may fail to be recognized with ease. In some cases, hardly any ground layers may exist outside the bleeding portions 42, or in contrast, hardly any bleeding portions 42 may exist inside the ground layers.

In the present embodiment, the sidewall 18 is formed having a width of 8 mm, and each ground layer 31a or 31b is also formed having a width of 8 mm to be conformable to it. Each ground layer 31a or 31b is formed having a thickness of 12 μm. The sealing layer 32 of indium is formed having a thickness of 0.3 mm and a width of 6 mm.

The inventors thereof advanced various examinations on the sealing portion 33, and confirmed that the incidence of breakage of the sealing layer 32 with the sealant electrically heated was greatly influenced by the thickness of the ground layer 31a or 31b. When the respective thicknesses of the ground layers of broken substrates were measured, all of them were found to be less than 5 μm. When the thickness of the ground layer 31a or 31b was adjusted to 5 μm or more, the incidence of sealing layer breakage even in the baked substrates was drastically lowered. When the thickness was adjusted to 8 μm or more, hardly any breakage occurred. It was confirmed that the occurrence of breakage was also influenced by the widths of the ground layers 31a and 31b. When the ground layer thickness was adjusted to 12 μm or more, no sealing layer breakage occurred without regard to the ground layer width or conditions for a sealing process and its preceding processes.

Since the ground layers 31a and 31b and the first and second substrates 11 and 12 or the sidewall 18 are formed of different materials, on the other hand, they have different thermal expansion coefficients. If the ground layers 31a and 31b are too thick, therefore, boundaries between the ground layers and the substrates sometimes may be broken by a residual stress that is attributable to the difference between the thermal expansion coefficients during a heating process in several weeks after the completion of the image display device, although no special problems arise during the manufacture. As a result of various examinations conducted on such interfacial breakdown, it was confirmed that no interfacial breakdown occurred when the thicknesses of the ground layers 31a and 31b were adjusted to 22 μm.

If the sealing layer 32 is formed by loading indium onto the ground layers 31a and 31b, the width of the sealing layer 32 should preferably be made smaller than the width of the ground layers. If the width of the sealing layer 32 exceeds the width of the ground layers 31a and 31b, the indium may slip off the ground layers and touch the substrate surfaces when the indium is melted by electric heating. Possibly, in this case, breakage of the sealing layer may occur starting at the point of the contact. Preferably, the width of the sealing layer 32 should be adjusted to 3 mm or more. It is confirmed that if the width is less than this value, the display device may involve a problem in reliability of airtightness. Preferably, therefore, the width of the ground layers 31a and 31b should be adjusted to 4 mm or more in consideration of a maximum transverse dislocation or dispersion of 0.5 mm caused when the indium is loaded.

If the width of the ground layers 31a and 31b is too large, problems arise such that the ground layer thickness easily becomes uneven, the substrate size increases, wire arrangement is troublesome, the ground layers require so much material that the cost increases, etc. According to an examination by the inventors hereof, the width of the ground layers 31a and 31b should preferably be adjusted to 16 mm or less.

In consideration of these circumstances, the ground layers 31a and 31b are formed having thicknesses of 5 to 22 μm, and preferably to 8 to 14 μm. The width of the ground layers 31a and 31b ranges from 4 to 16 mm, and preferably from 7 to 11 mm.

In the FED constructed in this manner, video signals are applied to the electron emitting elements 22 and the electron emitting elements 22 formed in a simple matrix system. A gate voltage of +1,000 V is applied when the luminance based on the electron emitting elements is at its highest level. Further, +10 kV is applied to the phosphor screen 16. Thus, electron beams are emitted from the electron emitting elements 22. The size of the electron beams emitted from the electron emitting elements is modulated by the voltage of the gate electrodes 28. These electron beams excite the phosphor layers of the phosphor screen 16 to luminescence, thereby displaying an image.

The following is a detailed description of a manufacturing method for the FED constructed in this manner.

First, the phosphor screen 16 is formed on a plate glass to serve as the front substrate 11. In doing this, the plate glass with the same size as the front substrate 11 is prepared, and a phosphor stripe pattern is formed on the plate glass by using a plotter machine. The plate glass with the phosphor stripe pattern and a plate glass for the front substrate are placed on a positioning tool and set on an exposure table. By exposure and developing in this state, the phosphor screen is formed on the glass plate to serve as the front substrate 11. Thereafter, the metal back layer 17 is formed overlapping the phosphor screen 16.

Subsequently, the electron emitting elements 22 are formed on a plate glass for the rear substrate 12. In this case, the conductive cathode layer 24 is first formed on the plate glass, and a dielectric film for the silicon dioxide film is formed on the cathode layer by the thermal oxidation method, CVD method, or sputtering method. Thereafter, a metal film for gate electrode formation, such as molybdenum or niobium, is formed on the dielectric film by, for example, the sputtering method or electron-beam evaporation method. Then, resist patterns of shapes corresponding to the gate electrodes to be formed are formed on the metal film by lithography. The gate electrodes 28 are formed by etching the metal film by the wet etching method or dry etching method using the resist patterns as masks.

Thereafter, the cavities 25 are formed by etching the dielectric film by the wet or dry etching method using the resist patterns and the gate electrodes 28 as masks. After the resist patterns are then removed, a release layer of, e.g., aluminum or nickel is formed on the gate electrodes 28 by subjecting the rear substrate surface to electron-beam evaporation from a direction at a given angle thereto. Thereafter, a cathode formation material of, e.g., molybdenum is deposited on the rear substrate surface from a direction at right angles thereto by the electron-beam evaporation method. Thereupon, the electron emitting elements 22 are formed individually in the cavities 25. Then, the release layer, along with the metal film thereon, is removed by the lift-off method.

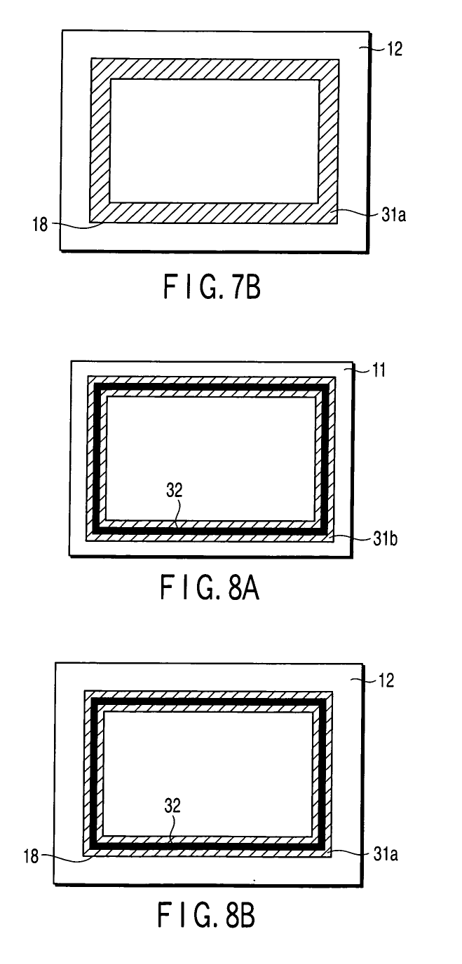

Subsequently, the sidewall 18 and the support members 14 are sealed on the inner surface of the rear substrate 12 by the low-melting-point glass 19. As shown in FIGS. 7A and 7B, thereafter, a silver paste is screen-printed to a width of 8 mm and a thickness of 18 μm on the sealed surface of the sidewall 18, covering its entire circumference. Likewise, a silver paste is screen-printed to a width of 8 mm and a thickness of 18 μm on the sealed surface of the front substrate 11 that faces the sidewall. Thereafter, the ground layers 31a and 31b are formed by individually firing the first and second substrates 11 and 12 at 500° C. The silver paste is shrunk in its thickness direction by the firing, whereupon the thicknesses of the ground layers 31a and 31b are reduced to 12 μm.

Then, as shown in FIGS. 8A and 8B, indium as a conductive low-melting-point sealant is loaded to a width of 4.4 mm and a thickness of 0.3 mm onto the ground layers 31a and 31b of the first and second substrates 11 and 12 by ultrasonic heating. The frame-shaped sealing layer 32 is formed extending throughout the entire circumferences of the ground layers 31a and 31b.

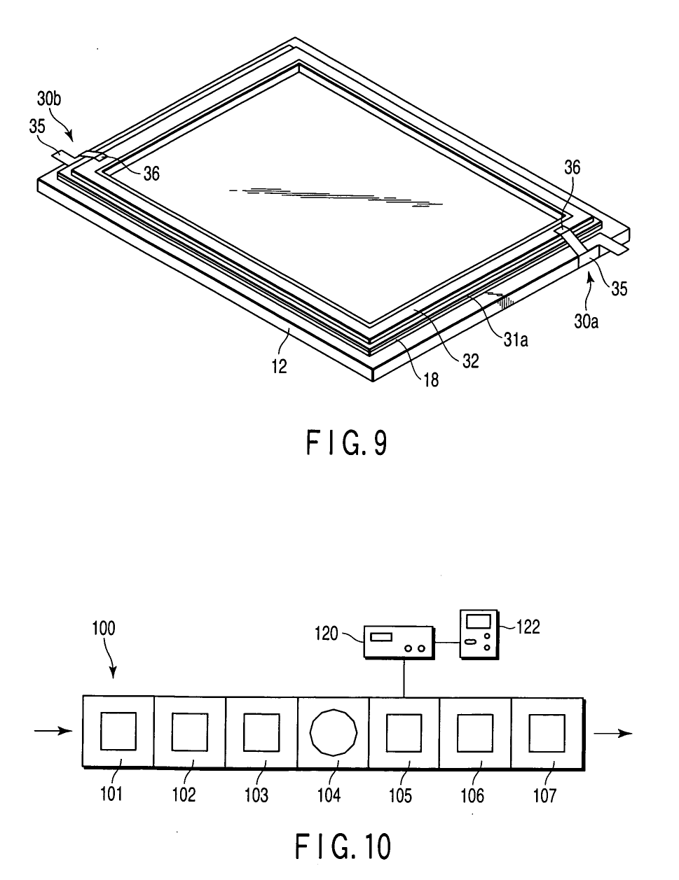

Subsequently, as shown in FIG. 9, a pair of electrodes 30a and 30b are attached to the rear substrate 12 to which the sidewall 18 is sealed. These are mounted in a manner such that it elastically engages the rear substrate 12. Specifically, the electrodes 30a and 30b for current supply are mounted on the rear substrate 12 with the peripheral edge portion of the rear substrate 12 elastically nipped by clip portions 35. As this is done, contact portions 36 of the electrodes 30a and 30b on the sidewall 18 are brought into contact with the sealing layer 32 so that the electrodes are connected electrically to the sealing layer.

The electrodes 30a and 30b are used as electrodes for energizing the sealing layer 32, and a pair of electrodes, positive and negative, are required on the substrate. Preferably, conduction paths for the sealing layer through which currents are supplied in parallel between the pair of electrodes should be made equal. To attain this, the pair of electrodes 30a and 30b are mounted individually near two diagonally opposite corner portions of the rear substrate 12, and the respective lengths of those portions of the sealing layer which are situated between the electrodes are substantially equal on the opposite sides of each electrode.

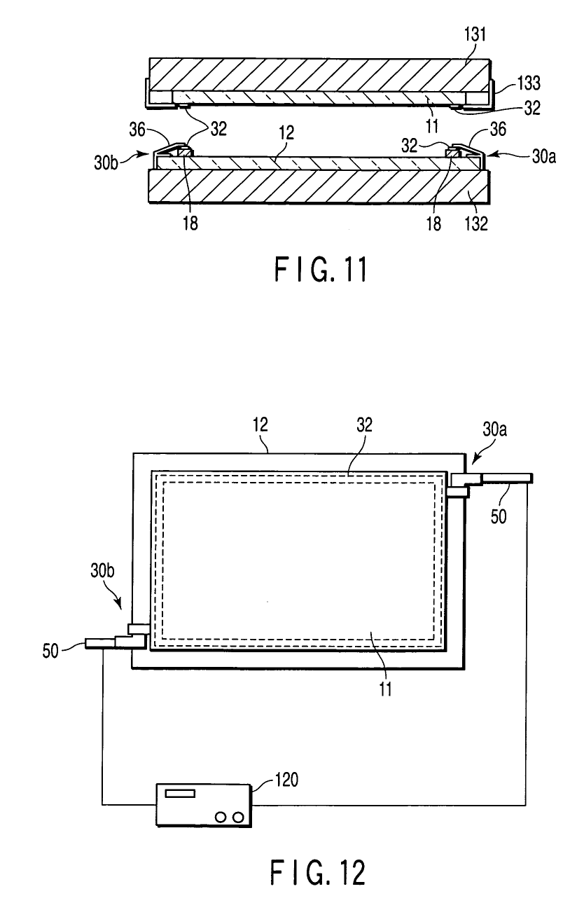

After the electrodes 30a and 30b are mounted, the rear substrate 12 and the front substrate 11 are opposed to each other with a predetermined space between them, and in this state, put into a vacuum processor. For example, a vacuum processor 100 shown in FIG. 10 is used for this purpose. The vacuum processor 100 comprises a loading chamber 101, baking and electron-beam cleaning chamber 102, cooling chamber 103, getter film evaporation chamber 104, assembly chamber 105, cooling chamber 106, and unloading chamber 107. The assembly chamber 105 is connected with a DC power source 120 for current supply and a computer 122 for controlling the power source. Each chamber of the vacuum processor 100 is constructed as a processing chamber that permits vacuum processing. All the chambers are evacuated during the manufacture of the FED. These individual processing chambers are connected by gate valves (not shown).

The front substrate 11 and the rear substrate 12, arranged spaced as described above, are first put into the loading chamber 101. After an atmosphere in the loading chamber 101 is then reduced to a vacuum atmosphere, the substrates are delivered into the baking and electron-beam cleaning chamber 102. In the baking and electron-beam cleaning chamber 102, various members are heated to a temperature of 350° C., and a surface-adsorbed gas on each substrate is released. At this temperature, the indium that forms the sealing layer 32 melts. Since the indium is formed on the ground layers 31a and 31b that have high affinity, however, it can be held on the ground layers without flowing, so that it can be prevented from flowing outward from the substrates or toward the electron emitting elements 22 or the phosphor screen 16.

At the same time, electron beams from a electron beam generator (not shown) that is attached to the baking and electron-beam cleaning chamber 102 are applied to a phosphor screen surface of the front substrate 11 and an electron emitting element surface of the rear substrate 12. In doing this, the electron beams are deflected for scanning by a deflector that is attached to the outside of the electron beam generator, whereupon the phosphor screen surface and the entire surfaces of the electron emitting elements are cleaned individually with the electron beams.

After the electron-beam cleaning, the front substrate 11 and the rear substrate 12 are delivered to the cooling chamber 103. After they are cooled there to a temperature of about 120° C., the substrates are sent to the getter film evaporation chamber 104. In this evaporation chamber 104, a barium film is formed as the getter film 27 outside the metal back layer 17 by vapor deposition. The surface of the barium film can be prevented from soiled by oxygen or carbon, so that its active state can be maintained.

Subsequently, the front substrate 11 and the rear substrate 12 are delivered to the assembly chamber 105. As shown in FIG. 11, hotplates 131 and 132 for heat retention are held, respectively, in close contact with the front substrate 11 and the rear substrate 12 that are opposed to each other. The front substrate 11 has its peripheral portion fixed by fixing jigs 133 lest it fall. The front substrate 11 and the rear substrate 12 are heated to given temperatures by the hotplates 131 and 132.

Thereafter, the front substrate 11 and/or the rear substrate 12, e.g., both substrates in this case, are pressurized toward each other at a desired pressure. As this is done, the respective contact portions 36 of the electrodes 30a and 30b are sandwiched between the respective sealing layers 32 of the two substrates. Thereupon, the electrodes are brought simultaneously into electrical contact with the sealing layers 32 of the substrates 11 and 12.

In this state, as shown in FIG. 12, a DC current of 140 A is supplied in a constant-current mode from the power source 120 to the sealing layers 32 through a pair of feed terminals 50 and the pair of electrodes 30a and 30b. As this is done, the indium melts in about 15 seconds and its temperature increases and exceeds about 200° C. in 20 seconds. Owing to this sudden temperature change, the surface tension and viscosity change, and wettability with the ground layers 31a and 31b varies. As the current is supplied, moreover, a magnetic field is generated in the indium, and the indium is subjected to a force toward its center by this magnetic field. The cross-sectional area changes after the indium is melted. Under these influences, the molten sealing layers 32 have their cross-sectional shapes changed with time and flow in an undulating manner as a whole. Since the ground layers 31a and 31b have a sufficient thickness of 12 μm, however, the sealing layers can be restrained from being broken. After the indium is melted, the width of the sealing layers is increased to 6 mm by pressurization, and a surplus of the indium flows into corner regions of the rear substrate 12 through the contact portions 36 of the electrodes 30a and 30b.

When the current supply is stopped, thereafter, the molten indium is cooled and solidified, and the front substrate 11 and the sidewall 18 are sealed together by the sealing layer 32, whereupon the vacuum envelope 10 is formed. The sealed vacuum envelope 10 is delivered to the cooling chamber 206, cooled to normal temperature therein, and taken out of the unloading chamber 207.

The image display device is completed in the processes described above. The electrodes 30a and 30b may be removed after the sealing.

In the FED and its manufacturing method described above, the ground layers 31a and 31b are formed of a material that has good airtightness and wettability with a conductive low-melting-point sealant, that is, a material with high affinity. The ground layers may be formed of any other metallic paste than the aforementioned silver paste, such as a gold, aluminum, nickel, or copper paste. Alternatively, a deposit of silver, gold, aluminum, nickel, or copper, a vapor deposition film, a sputtered film, or a glass material layer may be used in place of the metallic paste.

Besides the aforementioned indium, the low-melting-point sealant used may be a simple metal, selected from a group consisting of In, Ga, Pb, Sn, and Zn, or an alloy that contains at least one element selected from the group consisting of In, Ga, Pb, Sn, and Zn. It is desirable, in particular, to use In metal, Ga metal, or an alloy that contains at least one element selected from a group consisting of In and Ga. Since the low-melting-point sealant that contains In or Ga is highly wettable with a substrate of glass that consists mainly of SiO₂, it is particularly suited for the case where the substrate on which the low-melting-point sealant is located is formed of glass that consists mainly of SiO₂. In metal and an alloy that contains In are the most preferable low-melting-point sealants. Alloys that contain In may include, for example, an alloy containing In and Ag, alloy containing In and Sn, alloy containing In and Zn, alloy containing In and Au, etc. In the case of the present embodiment, the indium is a suitable material for the object of the present invention, which has outstanding features such that its melting point is as low as 156.7° C., its vapor pressure is low, it is soft and highly resistant to impact, and it never becomes brittle at low temperature.

The low-melting-point sealant used should be a low-melting-point metallic material that has a melting point of about 350° C. or less and is high in adhesion and bondability. If the melting point is higher than 350° C., the temperature of the substrates locally increases to cope with an increase in temperature of the low-melting-point sealant, and a great stress is generated in corner regions, in particular. Possibly, therefore, the substrates may be broken by electric heating. If no breakdown is caused, moreover, there is a possibility of the reliability of airtightness of the sealing layers 32 being lowered by a residual stress that is generated during the sealing process. If indium is used as the low-melting-point sealant, a temperature increase caused by the electric heating can be restricted to about 350° C., so that no substrate breakdown occurs. It was possible to confirm by an accelerated reliability test, therefore, that the airtightness reliability as the display device involved no problem.

According to the FED and its manufacturing method described above, the ground layers are formed having a sufficient thickness, so that breakage of the sealing layers can be prevented during electric heating, and sealing can be performed with good efficiency and high reliability. Thus, there may be provided an FED in which a reliable, satisfactory image can be obtained without failing to maintain the adsorption capacity of a getter and a manufacturing method therefor.

According to the FED and its manufacturing method according to the present embodiment, current can be steadily supplied to the sealant by the use of the electrodes. Further, a surface-adsorbed gas can be fully released by combining baking and electron-beam cleaning in the vacuum processor. Furthermore, a getter film with a good adsorption capacity can be obtained by performing getter evaporation at low temperature. By carrying out the electric heating, the necessity of heating the entire substrates can be obviated, so that degradation of the getter film can be prevented. At the same time, the sealing time can be shortened to less than 10 minutes, so that the manufacturing method can be enhanced in mass-productivity.

The present invention is not limited directly to the embodiment described above, and its components may be embodied in modified forms without departing from the spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In performing sealing in the assembly chamber 105, for example, the front substrate and the rear substrate may be separately supplied with currents so that the two substrates can be pressurized toward each other at a desired pressure after the sealant is melted. In this case, each substrate requires four electrodes arranged in two pairs. These electrodes are attached individually to four corners of the rear substrate 12. One pair of electrodes are used for current supply to the sealing layer on the side of the rear substrate 12, and the other pair of electrodes for current supply to the sealing layer on the side of the front substrate 11.

Further, the sidewall of the envelope may be molded integrally in advance with the rear substrate or the front substrate. It is to be understood that the external shape of the vacuum envelope and the configuration of the support members are not limited to the foregoing embodiment. Matrix-shaped light shielding layers and phosphor layers may be formed so that columnar support members having a cruciform cross section are positioned and sealed to the light shielding layers. The electron emitting elements used may be pn-type cold cathode elements or surface-conduction electron emitting elements. Although the process for joining the substrates in a vacuum atmosphere has been described in connection with the foregoing embodiment, the present invention may be also applied in any other ambient atmosphere. This invention is not limited to FEDs, but may be applied to any other image display devices, such as SEDs, PDPs, etc., or image display devices in which the interior of an envelope is not kept at high vacuum.

What is claimed is:

1. An image display device comprising a first substrate and a second substrate located opposite each other with a gap therebetween, and a sealing portion which seals the front and rear substrates in a given position and defines a sealed space between the front and rear substrates,
the sealing portion having a ground layer formed on an inner surface of at least one of the first substrate and the second substrate, and a sealing layer made of an electrically conductive sealant and formed on the ground layer, the ground layer having a thickness of 5 to 22 μm.

2. The image display device according to claim 1, wherein the ground layer is formed having a width of 4 to 16 mm.

3. The image display device according to claim 2, wherein the thickness of the ground layer ranges from 8 to 14 μm.

4. The image display device according to claim 1, wherein the ground layer has electrical conductivity.

5. The image display device according to claim 1, wherein the ground layer is formed of a metallic material which contains at least one of elements including silver, gold, aluminum, nickel, and copper.

6. The image display device according to claim 1, wherein the ground layer contains lead.

7. The image display device according to claim 1, wherein the sealant is formed of a low-melting-point metallic material having a melting point of 350° C. or less.

8. The image display device according to claim 7, wherein the low-melting-point metallic material is indium or an alloy which contains indium.

9. An image display device according to claim 1, wherein the sealing layer has a width smaller than the width of the ground layer and is formed overlapping the ground layer.

10. The image display device according to claim 1, wherein the sealing portion is provided along respective peripheral edge portions of the first substrate and the second substrate.

11. A method of manufacturing an image display device which comprises a first substrate and a second substrate located opposite each other with a gap therebetween and a sealing portion which seals the front and rear substrates in a given position and defines a sealed space between the front and rear substrates, the method comprising:
forming a ground layer to a thickness of 5 to 22 μm along an inner surface of at least one of the first and second substrates;
forming a sealing layer of an electrically conductive sealant on the ground layer; and
supplying current to the sealing layer to heat and melt the sealing layer with the front and rear substrates opposed to each other with the ground layer and the sealing layer sandwiched therebetween, and bonding the front and rear substrates together with the molten sealant.

12. The method of manufacturing an image display device according to claim 11, wherein the sealant is supplied with current after the sealing layer is formed overlapping the ground layer and having a width smaller than the width of the ground layer.
